(19) United States
(12) Patent Application Publication
(10) Pub. No.: US 2008/0032068 A1
(43) Pub. Date: Feb. 7, 2008

(54) System and Method for Temporarily Applying a Design to an Article

(76) Inventor: Kimberly Kennedy, Atlanta, GA (US)

Correspondence Address: SUTHERLAND ASBILL & BRENNAN LLP, 999 PEACHTREE STREET, N.E., ATLANTA, GA, 30309, US

(21) Appl. No.: 11/462,120

(22) Filed: Aug. 3, 2006

(51) Int. Cl. A47G 19/02; B44C 5/00

(52) U.S. Cl. 428/13; 29/428

(57) ABSTRACT

A kit for temporarily applying a design to an article having a first surface and a second surface distal the first surface is provided. The article is transparent through the first surface and the second surface. The kit comprises at least one decorative design element having the design, and a selectively removable reusable adherent sheet for temporarily affixing the at least one decorative design element adjacent to the first surface of the article so that at least a portion of the design is visible from the second surface of the article, wherein the selectively removable reusable adherent sheet is adapted to be repeatedly removably adhered to the first surface of the article and be removable from the at least one decorative design element. A method for temporarily applying a design to an article is also provided.

### TECHNICAL FIELD

This invention generally relates to temporarily applying decorative designs to articles, and more particularly, to temporarily applying decorative designs to dishware.

### BACKGROUND OF THE INVENTION

In various applications, it may be desirable to have decorative designs on articles used for different occasions or events. For example, the host of a party may want to present a particular theme or style to a table setting. Typically, this may be accomplished by using dishware having permanent designs which convey the particular theme or style desired. For instance, the dining plates, glassware, and dishes painted with snowflakes or snowmen may be coordinated to convey a winter theme for a winter party event. However, each different event would require different dishware. Therefore, it would be desirable to provide a convenient and economical system and method for providing different decorative designs on articles for different occasions.

### SUMMARY OF THE INVENTION

This disclosure provides a kit for temporarily applying a design to an article having a first surface and a second surface distal the first surface. The article is transparent through the first surface and the second surface. The kit comprises at least one decorative design element having the design and a selectively removable reusable adherent sheet for temporarily affixing the at least one decorative design element adjacent to the first surface of the article so that at least a portion of the design is visible from the second surface of the article. The selectively removable reusable adherent sheet is adapted to be repeatedly removably adhered to the first surface of the article and be removable from the at least one decorative design element.

In addition, this disclosure encompasses kit comprising an article having a first surface and a second surface distal the first surface, at least one decorative design element having a design, and a selectively removable reusable adherent sheet. The article is transparent through the first surface and the second surface. The selectively removable reusable adherent sheet temporarily affixes the at least one decorative design element adjacent to the first surface of the article so that at least a portion of the design is visible from the second surface of the article. The selectively removable reusable adherent sheet is also adapted to be repeatedly removably adhered to the first surface of the article and be removable from the at least one decorative design element.

Furthermore, a method for temporarily applying a design to an article having a first surface and a second surface distal the first surface is provided. The article is transparent through the first surface and the second surface. The method comprises providing at least one decorative design element having the design and affixing the at least one decorative design element adjacent to the first surface of the article temporarily with a selectively removable reusable adherent sheet so that at least a portion of the design is visible from the second surface of the article. The selectively removable reusable adherent sheet is adapted to be repeatedly removably affixed to the first surface of the article and be removable from the at least one decorative design element.

Other objects, features, and advantages of this invention will be apparent from the following detailed description, drawing, and claims.

### BRIEF DESCRIPTION OF THE DRAWINGS

FIG. 1A illustrates an exploded perspective view of a kit made in accordance with an embodiment of the present disclosure.

FIG. 1B illustrates a top view of the kit illustrated in FIG. 1A as assembled.

FIG. 1C illustrates a cross-sectional view of the assembled kit illustrated in FIG. 1B at plane C-C.

### DETAILED DESCRIPTION OF THE INVENTION

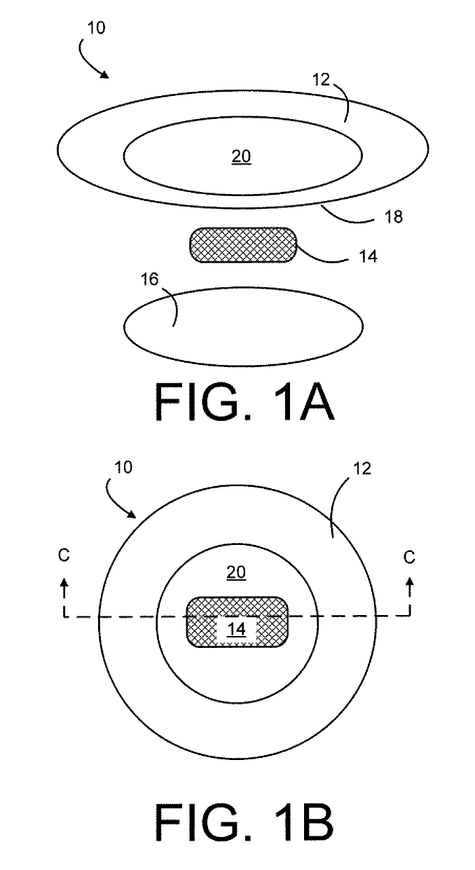

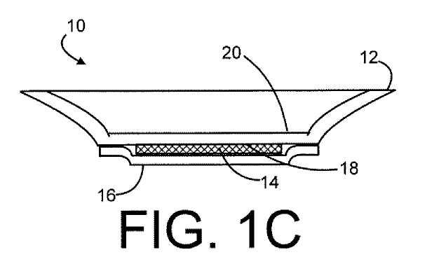

As summarized above, this disclosure encompasses a kit for temporarily applying a design to an article, a kit comprising an article, a decorative design element having a design, and a selectively removable reusable adherent sheet, and a method for temporarily applying a design to an article. The adherent sheet can be adhered to an article so that casual handling of the article by a person does not substantially move the adherent sheet or the decorative design element affixed to the article. In particular embodiments, the kit, when assembled, causes the decorative design element and the selectively removable reusable adherent sheet (also referred to herein as the “adherent sheet”) to appear integral to the article. However, if it is desired to remove the particular design from the article, the adherent sheet and decorative design element may be removed from the article. In addition to being removable from the article, the selectively removable reusable adherent sheet is removable from the decorative design element so that other decorative design elements with different designs may be affixed adjacent to the article using the same adherent sheet. Thus, a multitude of temporary designs may be applied to the same article. Embodiments of the kits and embodiments of the method for temporarily applying a design to an article are described in detail below and illustrated in FIG. 1.

FIG. 1A illustrates exploded perspective view of a kit 10 in accordance with one embodiment of the present invention comprising an article 12, a decorative design element 14 having a design, and a selectively removable reusable adherent sheet 16. FIG. 1B illustrates a top view of the kit 10 as assembled. FIG. 3B illustrates a cross-sectional view of the assembled kit. It should be understood that the thickness of the features shown in the Figures are not to scale and are exaggerated for purposes of identification and illustration. The article 12 has a first surface 18 and a second surface 20 distal the first surface. In addition, the article 12 is transparent through the first surface 18 and the second surface 20. The article 12 as illustrated is a clear glass dining plate. The first surface 18 comprises the bottom of the dining plate 12 and the second surface 20 comprises the top of the dining plate. However, it should be understood that the article 12 can be any article having a first surface 18 and a second surface 20 and which has some minimal degree of transparency through the first surface and the second surface such that the design of the decorative design element 14 is visible to the human eye through the second surface of the article. Examples of suitable articles 12 for embodiments of this invention include, but are not limited to dishware such as drinking glasses and bowls. In addition, the articles 12 may comprise glass, a ceramic, or plastic, for example.

As shown by the views illustrated in FIGS. 1A and 1C, the decorative design element 14 is positioned to be adjacent to the bottom 18 of the plate 12. The selectively removable reusable adherent sheet 16 is positioned on the side of the decorative design element 14 opposite the plate 12, A portion of the adherent sheet 16 is adhered to the bottom 18 of the plate 12 and thus, the decorative design element 14 is held adjacent and temporarily affixed to the bottom of the plate. Since the plate 12 is transparent through the bottom 18 and the top 20, the decorative design element 14 and the adherent sheet 16 are both visible through the first surface and the second surface. Thus, the design is temporarily applied to the plate 12.

According to particular embodiments of the invention, the decorative design element 14 can be any element visible to the human eye through the first surface 18 and the second surface 20 of the article 12 and capable of being temporarily affixed to the first surface of the article by the adherent sheet 16 without unreasonably inhibiting use of the article. Suitable decorative design elements 14 included, but are not limited to, a decorative sheet, paper, plastic, film, foil, laminate films, glitter, beads, feathers, coins, medals, ribbons, fabric, medallions, labels such as wine labels, printed transparencies, place cards, and the like. The design displayed by the decorative design element 14 may be imparted by the shape, color, texture, printing, or graphics of the design element or combination thereof. The decorative design element 14 may be used as a single element or in plurality on the article 12. For example, the decorative design element 14 may comprise a transparent sheet having a person's name printed thereon. In other embodiments, the decorative design element 14 may be free of adhesive, such that it neither adheres to the plate 12 or the adherent sheet 16, but is simply sandwiched therebetween. As illustrated in FIG. 1, the decorative design element 14 comprises a decorative sheet made of paper.

In particular embodiments, the selectively removable reusable adherent sheet 16 may comprise a flexible plastic sheet. For example, the selectively removable reusable adherent sheet 16 may comprise a flexible plastic sheet having a removable adherent surface (e.g., Ultra-Repositional™ from Protac Inc., Blaine, Minn.) or a flexible plastic sheet having a static cling vinyl surface (e.g., Cling Vinyl from Grafix®, Cleveland, Ohio). Removable adherent surfaces can be provided by a solvent and UV resistant acrylic adhesive surface formulation, as used on Ultra-Repositional. In particular embodiments, the adherent sheet 16 is removable from the article by a peel force easily applied by a human hand. Furthermore, in particular embodiments, the article 12, the decorative design element(s) 14, and the adherent sheet 16 are all easily removable from one another without damaging one another and repeatably reusable. In some embodiments, the selectively removable reusable adherent sheet 16 may be free of adhesive. In other embodiments, the selectively removable reusable adherent sheet 16 can be colored, have designs, or have no color or design. For example, the adherent sheet may be a cling vinyl sheet having a design printed on its periphery and a clear transparent middle portion or the adherent sheet may be a colored cling vinyl sheet having a designed printed throughout. In yet other embodiments, the selectively removable reusable adherent sheet 16 may be transparent, translucent, opaque, or have any degree of transparency.

Since the selectively removable reusable adherent sheet 16 must adhere to the article 12 to affix the decorative design element 14 adjacent to the first surface 18, it should be understood that the adherent sheet material should be chosen to temporarily adhere to the first surface, be removable from the first surface, and be removable from the decorative design element. As illustrated in FIG. 1, the selectively removable reusable adherent sheet 16 comprises a transparent, colorless static cling vinyl sheet. The static cling vinyl sheet 16 clings to the glass plate 12 and yet is removable from the glass plate and the decorative sheet 14 by a peel force. The static cling vinyl sheet 16 has an area greater than the area of the decorative sheet 14 so that a portion of the static cling vinyl sheet can contact and adhere to the bottom 18 of the plate 12 to hold the decorative sheet in place. As illustrated in FIG. 1, the shape of the static cling vinyl sheet 16 is substantially the same as the shape of the bottom 18 of the plate 12 and is transparent. Thus, in a particular embodiment, the static cling vinyl sheet 16 may be imperceivable or minimally perceivable to the human eye and the design of the decorative sheet 14 may appear to be integral with the plate 12.

According to particular embodiments of the invention, a method for temporarily applying a design to an article 12 having a first surface 18 and a second surface 20 distal the first surface is provided. The article 12 is transparent through the first surface 18 and the second surface 20 and can be the articles described above. The method comprises providing at least one decorative design element 14 having a design and affixing the at least one decorative design element adjacent to the first surface 18 of the article 12 temporarily with a selectively removable reusable adherent sheet 16 so that at least a portion of the design is visible from the second surface 20 of the article. The selectively removable reusable adherent sheet 16 is adapted to be repeatedly removably affixed to the first surface 18 of the article 12 and be removable from the at least one decorative design element 14. The decorative design elements 14 provided may be similar to the decorative design elements described above. Likewise, the selectively removable reusable adherent sheet 16 may be similar to the adherent sheets described above.

In one embodiment of the present invention, the method of the present invention may be used to apply a design to the clear glass plate 12 illustrated in FIG. 1. First, the decorative sheet is placed adjacent to the bottom 18 of the plate 12. For instance, the plate 12 may be placed on a surface with the bottom 18 of the plate facing up and the decorative sheet 14 is placed on the bottom of the plate so that the design is visible from the second surface 20 of the plate 12. Then, the static cling vinyl sheet 16 is affixed to the bottom 18 of the plate 12 by pressing the static cling vinyl sheet against the bottom of the plate and the decorative sheet 14 so that the periphery of the static cling vinyl sheet clings to the periphery of the bottom of the plate. Thus, the decorative sheet 14 is sandwiched between the bottom 18 of the plate 12 and the static cling vinyl sheet 16 to temporarily apply the design to the plate. When it is desired to remove the design from the plate 12, the static cling vinyl sheet 16 may be peeled away from the plate and the decorative sheet 14. Then, the decorative sheet 14 may be removed from the plate 12 and the plate, decorative sheet, and the adherent sheet 16 can be later reused.

It should be understood that the foregoing relates to particular embodiments and that numerous changes may be made therein without departing from the scope of this disclosure as defined from the following claims.

I claim:

1. A kit for temporarily applying a design to an article having a first surface and a second surface distal the first surface, the article being transparent through the first surface and the second surface, the kit comprising:
at least one decorative design element having the design; and
a selectively removable reusable adherent sheet for temporarily affixing the at least one decorative design element adjacent to the first surface of the article so that at least a portion of the design is visible from the second surface of the article, wherein the selectively removable reusable adherent sheet is adapted to be repeatedly removably adhered to the first surface of the article and be removable from the at least one decorative design element.

2. The kit of claim 1, wherein the selectively removable reusable adherent sheet comprises a flexible plastic sheet.

3. The kit of claim 1, wherein the at least one decorative design element has a first area, and wherein the selectively removable reusable adherent sheet comprises a flexible plastic sheet having a second area greater than the first area.

4. The kit of claim 3, wherein the flexible plastic sheet is a flexible plastic sheet having a removable adherent surface or has a static cling vinyl surface.

5. The kit of claim 3, wherein the flexible plastic sheet comprises a static cling vinyl sheet.

6. The kit of claim 1, wherein the selectively removable reusable adherent sheet is free of adhesive.

7. The kit of claim 1, wherein the selectively removable reusable adherent sheet is transparent.

8. The kit of claim 1, wherein the selectively removable reusable adherent sheet is colored or has a design printed thereon.

9. The kit of claim 1, wherein the at least one decorative design element is free of adhesive.

10. The kit of claim 1, wherein the at least one decorative design element comprises a decorative sheet, paper, plastic, film, foil, a laminate film, glitter, a bead, a feather, a coin, a medal, a ribbon, fabric, a medallion, a label, a wine label, a printed transparency, or a place card.

11. The kit of claim 1, wherein the at least one decorative design element has a first area and is free of adhesive, and wherein the selectively removable reusable adherent sheet comprises a transparent cling vinyl sheet having a second area greater than the first area.

12. The kit of claim 1, wherein the article is a piece of dishware selected from the group consisting of a dining plate, a drinking glass, or a bowl.

13. A kit comprising:
an article having a first surface and a second surface distal the first surface, the article being transparent through the first surface and the second surface;
at least one decorative design element having a design; and
a selectively removable reusable adherent sheet for temporarily affixing the at least one decorative design element adjacent to the first surface of the article so that at least a portion of the design is visible from the second surface of the article, wherein the selectively removable reusable adherent sheet is adapted to be repeatedly removably adhered to the first surface of the article and be removable from the at least one decorative design element.

14. The kit of claim 13, wherein the article comprises glass, a ceramic, or plastic.

15. The kit of claim 13, wherein the article is a dining plate having a bottom and a top, wherein the first surface of the article comprises the bottom of the dining plate and the second surface of the article comprises the top of the dining plate.

16. The kit of claim 13, wherein the article is a piece of dishware selected from the group consisting of a dining plate, a drinking glass, or a bowl.

17. The kit of claim 13, wherein the selectively removable reusable adherent sheet comprises a flexible plastic sheet.

18. The kit of claim 13, wherein the at least one decorative design element has a first area, and wherein the selectively removable reusable adherent sheet comprises a flexible plastic sheet having a second area greater than the first area.

19. The kit of claim 18, wherein the flexible plastic sheet is a flexible plastic sheet having a removable adherent surface or has a static cling vinyl surface.

20. The kit of claim 18, wherein the flexible plastic sheet comprises a static cling vinyl sheet.

21. The kit of claim 13, wherein the selectively removable reusable adherent sheet is free of adhesive.

22. The kit of claim 13, wherein the selectively removable reusable adherent sheet is transparent.

23. The kit of claim 13, wherein the selectively removable reusable adherent sheet is colored or has a design printed thereon.

24. The kit of claim 13, wherein the at least one decorative design element is free of adhesive.

25. The kit of claim 13, wherein the at least one decorative design element comprises a decorative sheet, paper, plastic, film, foil, a laminate film, glitter, a bead, a feather, a coin, a medal, a ribbon, fabric, a medallion, a label, a wine label, a printed transparency, or a place card.

26. The kit of claim 13, wherein the at least one decorative design element has a first area and is free of adhesive, and wherein the selectively removable reusable adherent sheet comprises a transparent cling vinyl sheet having a second area greater than the first area.

27. A kit for temporarily applying a design to an article having a first surface and a second surface distal the first surface, the article being transparent through the first surface and the second surface, the kit comprising:
at least one decorative design element having the design; and
a means for temporarily affixing the at least one decorative design element adjacent to the first surface of the article so that at least a portion of the design is visible from the second surface of the article, wherein the means for affixing is adapted to be repeatedly removably adhered to the first surface of the article and be removable from the at least one decorative design element.

28. A method for temporarily applying a design to an article having a first surface and a second surface distal the first surface, the article being transparent through the first surface and the second surface, the method comprising:
providing at least one decorative design element having the design; and
affixing the at least one decorative design element adjacent to the first surface of the article temporarily with a selectively removable reusable adherent sheet so that at least a portion of the design is visible from the second surface of the article, wherein the selectively removable reusable adherent sheet is adapted to be repeatedly removably affixed to the first surface of the article and be removable from the at least one decorative design element.

29. The method of claim 28, wherein the selectively removable reusable adherent sheet comprises a static cling vinyl sheet.
